(19) United States
(12) Patent Application Publication
(10) Pub. No.: US 2016/0134783 A1
(43) Pub. Date: May 12, 2016

(54) LAB VALUE CONVERSION BASED ON PRIVATE TAG

(71) Applicant: XEROX CORPORATION, Norwalk, CT (US)

(72) Inventors: Guo-Yau Lin, The Woodlands, TX (US); J. Michael Sanchez, Rochester, NY (US)

(21) Appl. No.: 14/539,139

(22) Filed: Nov. 12, 2014

(51) Int. Cl. H04N 1/60

(52) U.S. Cl. CPC H04N 1/6058; H04N 1/6016

(57) ABSTRACT

Lab value conversion based on a provide tag is disclosed. A determination may be made that spot processing is enabled. A profile may be accessed based on the determination that spot processing is enabled. A private tag may be identified in the profile. Lab values may be converted based on the identified private tag. A private tag may also be selected by the user based on the attribute mapping.

### TECHNICAL FIELD

Embodiments are generally related to image processing methods and systems. Embodiments are also related to rendering and calibration systems and techniques. Embodiments are also related to the conversion of spot colors.

### BACKGROUND

To meet customer demand, the commercial printing industry requires the capability of producing or emulating spot colors accurately and consistently. Spot colors can be defined as a fixed set of colors which may be Pantone® colors, customer logo colors, colors in a customer's proprietary marked patterns, or customer defined colors in the form of an index color table. Spot colors are often used, or can be used, for large background areas, which may be the most color critical portion of a particular page. Consistent color in these areas may determine the difference between success and failure in meeting customer requirements.

Since imaging can occur over a variety of different printing systems and practiced by a variety of different clients and customers, the colors may not always be consistent or accurate. Existing spot color editors utilize a manual approach to the adjustment of CMYK (cyan, magenta, yellow, black) recipes of spot colors prior to raster image processing. For example, a document creator may select a Pantone® color for application in specific areas through a user interface on a printing device or computer monitor, such as that available on a Xerox® FreeFlow Print Server® Controller. The Pantone® provided CMYK recipe for the selected printer is obtained from a look-up table. Prior to raster mage processing the document in the printer, the operator has the option of entering a spot color editor function and specifying an alternative CMYK recipe to achieve the desired color. The document is then raster image processed and printed using the spot color editor recipes where specified, and Pantone® recipes otherwise.

Thus, spot color reproduction is a desirable property in the printing industry. There are different methods to reproduce accurate spot colors on a printer system, such as ICC (international color consortium) profile, iterating printer model, or directly iterating on a printer. However, regardless of what methods are used, only in-gamut spot colors may be reproduced accurately. For out-of-gamut spot colors, some gamut mapping methods have to be applied to map these colors onto a gamut surface. In such a case, a noticeable color difference between the target spot color and the final reproduction cannot be avoided.

### BRIEF SUMMARY

The following summary is provided to facilitate an understanding of some of the innovative features unique to the present disclosure and is not intended to be a full description. A full appreciation of the various aspects of the embodiments disclosed herein can be gained by taking the entire specification, claims, drawings, and abstract as a whole.

As discussed herein, Lab value conversion based on a provide tag is disclosed. A determination may be made that spot processing is enabled. A profile may be accessed based on the determination that spot processing is enabled. A private tag may be identified in the profile. Lab values may be converted based on the identified private tag.

### I. BRIEF DESCRIPTION OF THE DRAWINGS

The accompanying figures, in which like reference numerals refer to identical or functionally-similar elements throughout the separate views and which are incorporated in and form a part of the specification, further illustrate the present disclosure and, together with the detailed description of the disclosure, serve to explain the principles of the present disclosure.

FIG. 1 illustrates an example of a rendering device coupled to a data-processing apparatus through a network, in accordance with some embodiments of the present disclosure;

FIG. 2 illustrates a block diagram of a spot color rendering system, in accordance with some embodiments of the present disclosure;

FIG. 3 illustrates an example flow diagram illustrating an example process for converting Lab values, in accordance with some embodiments of the present disclosure;

FIG. 4 illustrates an example flow diagram illustrating an example process for converting Lab values, in accordance with some embodiments of the present disclosure; and

FIG. 5 depicts an example rendering device, in accordance with some embodiments of the present disclosure.

### DETAILED DESCRIPTION

The particular values and configurations discussed in these non-limiting examples can be varied and are cited merely to illustrate at least one embodiment and are not intended to limit the scope thereof.

Traditionally spot color processing is device-dependent, i.e. utilizing a static table that stores device colorant formula for each named color. Other systems may provide a process that manages colors across different printers where the target device independent color values (e.g. Lab values) are store in the look-up table. The mapping from device independent color space to device colorants is done through the Relative Colorimetric rendering intent in the selected destination profile on the fly during the RIP (raster image processing). Other systems provide a more sophisticated approach where the private tag was utilized rather than the Relative Colorimetric. This enables a customized control of gamut mapping (for example, a combination of nearest and hue preservation) that mimics some specific gamut mapping strategy used by the industry. This approach may provide for the spot color gamut mapping to a specific method across different spot color libraries. In addition, one printer type (gamut) may be optimized with only one gamut mapping type. Multiple gamut mapping can be achieved by providing multiple ICC profiles, but such implementation may result in exponentially increasing resources to manage.

As discussed herein, according to some examples, multiple private tags may be implemented for different spot color libraries. Multiple private tags may be stored in an ICC profile. Each of the tags may specify a specific gamut mapping, for example, one for each spot color system. An inversion method may be used to build the Lab->CMYK LUT for the spot colors that fall inside the printer gamut. The RIP system may detect the spot color name and determine which spot color system the named color belongs to. The system may switch to using the specific private tag for that spot color library.

According to some other examples, multiple private spot tags may be implemented for the same spot color library, but with different attributes, for example, saturated levels, etc.

In each of these examples, the rendering intent may be driving the use of a specific private tag through automatic rendering intent switching.

Thus, as discussed herein, a computer-implemented method, apparatus, and computer-readable storage medium, storing a set of instructions to perform a method, is provided, including determining, via a processor, that spot processing is enabled; accessing, via a processor, a profile based on the determination that spot processing is enabled; identifying, via a processor, a private tag in the profile; and converting the Lab values based on the identified private tag.

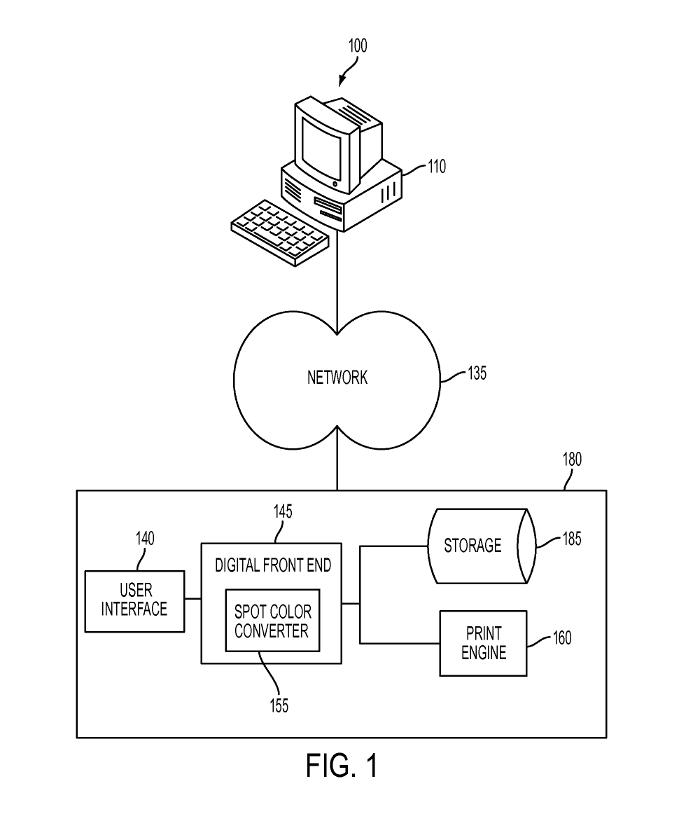

FIG. 1 is provided as an example diagram of a data processing environment in which embodiments of the present disclosure may be implemented. It should be appreciated that FIG. 1 is only an example and is not intended to assert or imply any limitation with regard to the environments in which aspects or embodiments as discussed herein may be implemented. Many modifications to the depicted environments may be made without departing from the spirit and scope of the present disclosure.

FIG. 1 depicts a system 100 that includes a rendering device 180 coupled to a data-processing apparatus 110 through a network 135. The data-processing apparatus 110 may be, for example, a personal computer or other computing device (e.g., a laptop computer, wireless cellular telephone, Smartphone, server, etc.) and may generally includes a central processor, a display device, input/output devices, for example, a keyboard, a pointing device (e.g., mouse, track ball, pen device, or the like), etc. Additional input/output devices, such as the rendering device 180, may be included in association with the data-processing apparatus 110 as desired.

Note that as utilized herein, the term rendering device may refer to an apparatus or system such as a printer, scanner, fax machine, copy machine, etc., and/or a combination thereof. Rendering device 180 may be capable of multiple rendering functions such as printing, copying, scanning, faxing, etc. In some embodiments, rendering device 180 may be implemented with a single rendering function such as printing. In other embodiments, rendering device 180 can be configured to provide multiple rendering functions such as scanning, faxing, printing and copying.

The data-processing apparatus 110 may be coupled to the rendering device 180 through a computer network 135. Network 135 may employ any network topology, transmission medium, or network protocol such as, for example, a computer network, Ethernet, Internet, Intranet, etc. Network 135 may include connections such as wire, wireless communication links, or fiber optic cables. The data-processing apparatus 110 may include a graphical user interface (GUI) that displays information and receives data through device display and/or the keyboard/mouse combination. The GUI also serves to display results, whereupon the user may supply additional inputs or terminate a given session.

A rendering device driver program may be installed on the data-processing apparatus 110 and may reside on the data-processing apparatus 110. The rendering device driver program may be activated through an application interface so that a user may generate a print job with the driver for processing by the rendering device 180. The rendering device 180 can be configured to include a user interface 140, a Digital Front End (DFE) component 145, and a print engine 160. Note that the term digital front end or DFE, as discussed herein, generally refers to the central management component of the digital printing system of rendering device 180. The DFE component 145 is capable of loading files from various network sources associated with network 135 and processes the files so they can be outputted on various digital equipment, whether it be a small desktop printer or a large digital press. The digital front end (DFE) component 145, in most cases, is a unit that accepts and processes files for variable data applications and also pulls information from a database 185 for more personalized documents. The DFE component 145 provides consistency in color, quality, and accuracy.

The user interface 140 associated with the rendering device 180 may include, for example, a graphically displayed panel menu that provides various input and selection features to enter data into the rendering device 180. Such a user interface may include, for example, touch screens having touch activated keys for navigating through an option menu or other input devices.

The DFE component 145 may access spot color converter 155 that assists with conversion of spot colors, typically embodied in software, and also components that enable image processing and control functions such as those described herein. It can be appreciated that spot color converter 155 can also be accessed through a pre-press system.

Note that as utilized herein, the term “component” may refer to a physical hardware component and/or to a software component. In the computer programming arts, such a software “component” may be implemented as a collection of routines and data structures that performs particular tasks or implements a particular abstract data type.

The methodology described herein can be implemented as a series of such components or as a single software component. Such components can be utilized separately or together to form a program product that can be implemented through signal-bearing media, including transmission media and recordable media.

A user can access and operate the rendering device 180 utilizing the user interface 140 and/or via the data-processing apparatus 110. A user profile, work product for printing, media library, print job parameters, and so forth can be stored in database 185, which is accessible by the data-processing apparatus 110 or rendering device 180 via the network 135, or can be directly accessed via the rendering device 180. The user interface 140 can be used to communicate particular rendering device features for processing a rendering job to a user and accepting the user's selection of available rendering device features. The user interface 140 also serves to display results, whereupon the user may supply additional inputs or terminate a given session.

The following description is presented with respect to embodiments of the present disclosure, which can be embodied in the context of a data-processing apparatus 110 and rendering device 180 depicted in FIG. 1. The present disclosure, however, is not limited to any particular application or any particular environment. Instead, those skilled in the art will find that the system and methods of the present disclosure may be advantageously applied to a variety of system and application software, including database management systems, word processors, and the like. Moreover, the present disclosure may be embodied on a variety of different platforms, including Macintosh, UNIX, LINUX, and the like. Therefore, the description of the exemplary embodiments, which follows, is for purposes of illustration and not considered a limitation.

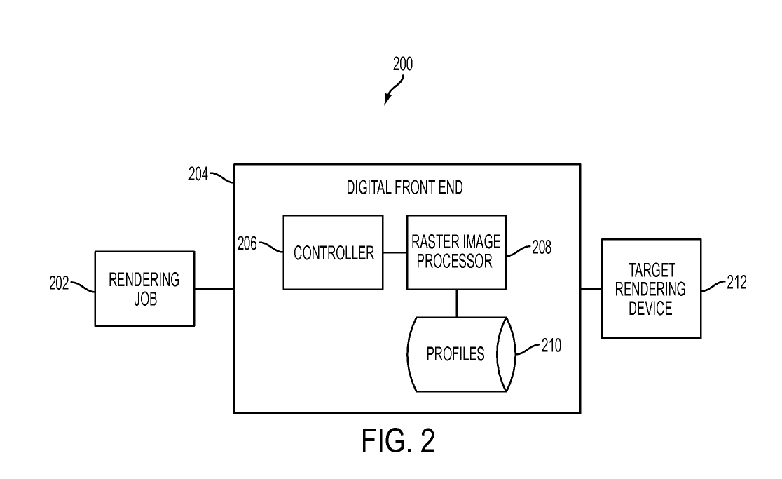

FIG. 2 illustrates a block diagram of a spot color rendering system 200, in accordance with an embodiment. The system 200 can be utilized to render a spot color associated with a rendering job 202 (e.g., print job) via rendering processes. The spot color can be defined as any color generated by an ink (pure or pre-mixed) that is rendered using a single run. The digital emulation process is often composed of four spot colors namely cyan, magenta, yellow, and key (black), commonly referred to as CMYK. The term spot color refers generally, however, to any color generated by a non-standard offset ink such as metallic, fluorescent, spot varnish, or custom hand-mixed inks. The system 200 analyzes a rendering job 202 and determines a spot color name in the rendering job. The spot color name calls are generally associated with one or more color values defined in an ICC profile stored in profiles storage 210. An ICC profile is a set of data that characterizes a color input or output, or rendering, device, or a color space, according to standards promulgated by the International Color Consortium (ICC). ICC profiles describe the color attributes of a particular device or viewing requirement by defining a mapping between the device source or target color space and an ICC profile, or ICC profile connection space (PCS). This PCS may be, for example, CIELAB (L*a*b*) or CIEXYZ. Mappings may be specified using tables, to which interpolation is applied, or through a series of parameters for transformations.

As discussed herein, an ICC profile, stored in profiles storage 210, may further include multiple private tags. A private tag specifies a gamut mapping, and the transformation from the PCS to the device space. There may be one private tag for each spot color system. As an example, the profile generated from the current Xerox FFPS DFE contains two private tags, one for general spot color mapping, and one for Pure rendering intent. The concept of this invention is to introduce multiple spot color mappings, so a single profile can be used for different types of spot mappings.

The RIP 208 may access the profiles and use the tags in the profiles in order to convert the lab values to CMYK based on the gamut mapping in the tag. Specifically, the RIP 208 detects the spot color name and determines which spot color system that named color belongs to. The RIP then switches to using the specific private tag for that spot color library.

It may be appreciated that, as discussed herein, RIP 208 refers generally to a component used in the printing system, which produces a raster image also known as a bitmap. The bitmap is then sent to a printing device for output. The input may be a page description in a high-level page description language such as PostScript, Portable Document Format, XPS or another bitmap of higher or lower resolution than the output device. In the latter case, the RIP applies either smoothing or interpolation algorithms to the input bitmap to generate the output bitmap. Raster image processing is the process and the means of turning vector digital information such as a PostScript file into a high-resolution raster image.

The information processed by DFE 204 may be provided to a target rendering device 212 for rendering.

Controller 206 may be implemented to control the processes in DFE 204.

According to some examples discussed herein, multiple private tags may be implemented for the same spot color library, where different private tags for the same spot color library may have different attributes, for example saturation levels, etc.

Thus, the rendering intent is driving the use of a specific private tag through automatic rendering intent switching.

By utilizing multiple private tags in the ICC profile, different spot color libraries (for example, PANTONE, DIC, TOYO, etc.) may have their own gamut mapping strategy. As the different color libraries are products of different companies, they may have different criteria or requirements for mapping out-of-gamut colors and colors near the gamut boundary.

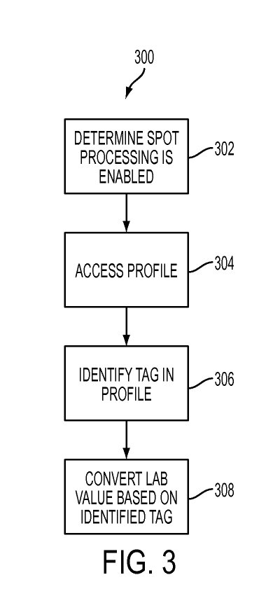

FIG. 3 depicts an example flow diagram of a process 300 for converting lab values to CMYK. In this example, Spot-tag_PANTONE and Spot-tag_DIC may be stored as different private tags in an ICC profile. Spot-tag_PANTONE and Spot-tag_DIC private tags may include different gamut mapping strategies. The process depicted in FIG. 3 may be implemented by, for example, system 200, rendering device 180, etc.

A rendering job including spot color reference data may be received/accessed. As shown in FIG. 3, a determination may be made that spot processing is enabled (302). For example, the determination may be made based on enabling of a setting, etc. According to some examples, if spot processing is not enabled, an alternative color transformation may be selected and utilized.

After determining that spot processing is enabled, based on a spot color name, a spot color library including the spot color name is determined. A profile is accessed (304). For example, an ICC profile may be accessed. The ICC profile may include multiple private tags, wherein each of the multiple private tags include a gamut mapping strategy for different spot color libraries.

A private tag may be identified in the provide (306). For example, where the spot color library is PANTONE, the private tag SpotTag_PANTONE may be identified. In another example, where the spot color library is DIC, the private tag SpotTag_DIC may be identified.

After a private tag is identified, the Lab values may be converted based on the identified tag (308). For example, where the SpotTag_PANTONE private tag is identified, the Lab values may be converted based on the gamut mapping strategy in the SpotTag_PANTONE tag.

Once the Lab values are converted, processing may proceed to output the rendering job to a rendering device.

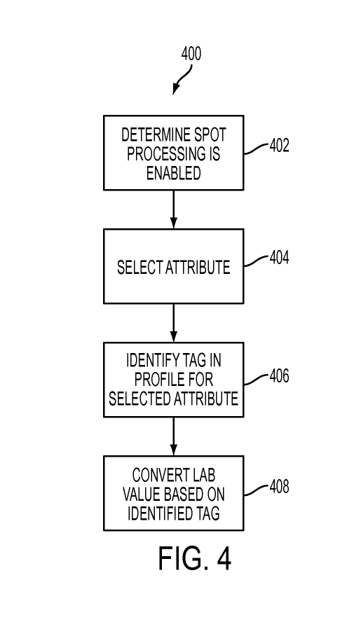

FIG. 4 depicts an example process 400 for converting Lab values. The process depicted in FIG. 4 may be performed by system 200, rendering device 180, etc.

A rendering job including spot color reference data may be received/accessed. As shown in FIG. 4, a determination may be made that spot processing is enabled (402). If spot processing is not enabled, an alternative color transformation may be utilized. As discussed with regard to FIG. 4, and in accordance with some embodiments of the present disclosure, different private tags may be stored for different gamut mapping attribute levels. Some examples of different attributes may include one or more of: reproduce in-gamut color as much as possible, attempt to accurately reproduce the in-gamut colors, but gradually relax the accuracy in order to create visual color separation near the printer gamut boundary, etc. These attributes may be selected, for example, based on an object to rendered, based on user input, etc.

For example, a smaller gamut might result in a gamut mapping type that, in order to yield most saturation for PANTONE Coated library, results in a many-to-one mapping. However, with multiple tags, this problem can be alleviated when it arises, but providing a separate spot color tag that also provides gamut mapping type that compromises saturation in favor of visual color separation. Many other examples of providing different prioritized gamut mappings within one RIP system for spot colors can be appreciated for a single printer with single spot color library enabling a multiplicity of outcomes for customers to choose from, and to meet their specific requirements.

As shown in FIG. 4, a spot color library may be determined based on a spot color name. A profile for the determined spot color library may be accessed, where the profile includes multiple private tags. A set of the multiple private tags may include gamut mapping attribute levels.

An attribute may be selected (404). The attribute may be selected based on user input, based on the object to be rendered, etc.

A private tag in the accessed profile may be identified based on the selected attribute (406). The Lab values may be converted based on the identified private tag (408). As the private tag includes gamut mapping attribute levels, the Lab values may be converted utilizing the gamut mapping attribute levels in the private tag.

The processed information may be provided to a target rendering device for rendering.

According to some embodiments, the attribute selection may be automatically performed by system 200, rendering device 185, etc., based on predefined rules. For example, where the image object is colored by spot colors, visual color separation is important. Thus, the system may access predefined rules that choose less accurate mapping near the printer gamut boundary. In another example, for text and/or graphics, object color accuracy may have a higher priority than visual separation. Thus, the system may access predefined rules that indicate use of accurate mapping for in-gamut colors, while leaving some many-to-one mappings for out-of-gamut spot colors. In another example, for in-gamut colors, the color table may produce accurate colors, while for out-of-gamut colors, different private tags may carry different gamut mapping methods, for example, hue preservation, lightness preservation, nearest, any combination thereof, etc.

As discussed herein, the color values can be determined by searching a spot color name in the database 185. The database 185 can be configured to include a relation of the spot color name with its associated PCS numerical value and enable association of the color name with a resultant color transformed output. These values represent the color values of the actual spot color name as denoted by spot color reference data. In case of Pantone spot color names, for example, the color value can represent the color as it exists from the Pantone coated swatch book.

The PCS version of the spot color (L*a*b* or XYZ) can be utilized to convert Lab by the identified or selected private tag, which also has the gamut mapping method baked in.

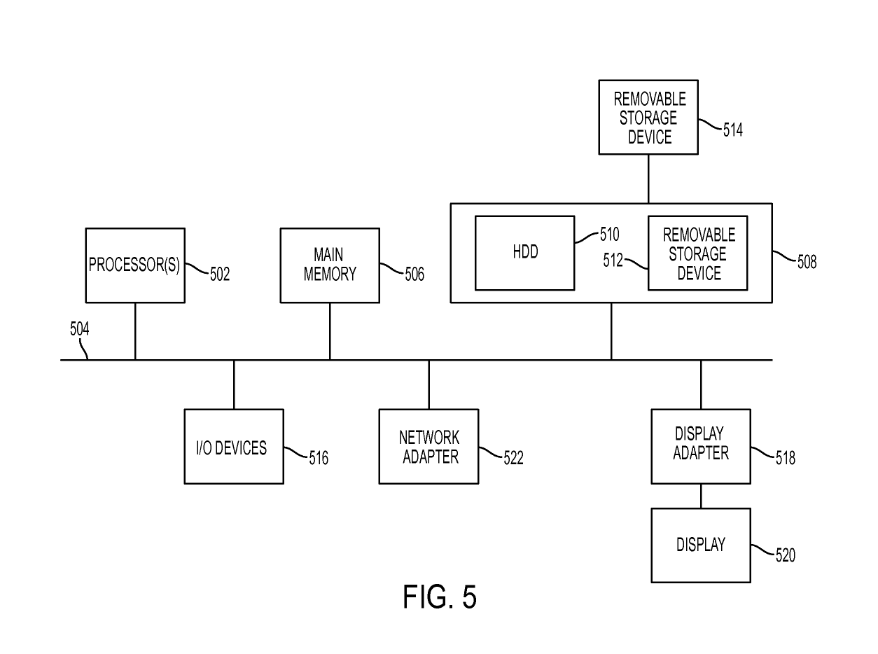

FIG. 5 is a block diagram of an exemplary computing system or data processing system 500 that may be used to implement some embodiments consistent with the present disclosure. Other components and/or arrangements may also be used. In various embodiments, computing system 500 may be used to implement components implementing functionality associated with converting lab values as depicted in FIG. 1 and FIG. 2.

Computing system 500 includes a number of components, such as a central processing unit (CPU) 505, a memory 510, an input/output (I/O) device(s) 525, and a nonvolatile storage device 520. System 500 may comprise CPU 505, memory 510, nonvolatile storage 520, and I/O devices 525. In such a configuration, components 505, 510, 520, and 525 may connect and communicate through a local data bus and may access a database (implemented, for example, as a separate database system) via an external I/O connection. I/O component(s) 525 may connect to external devices through a direct communication link (e.g., a hardwired or local wifi connection), through a network, such as a local area network (LAN) or a wide area network (WAN), and/or through other suitable connections. System 500 may be standalone or it may be a subsystem of a larger system.

CPU 505 may be one or more known processing devices, such as a microprocessor from the Core™ family manufactured by the Intel™ Corporation of Santa Clara, Calif., or the like. Memory 510 may be non-transitory and implemented as one or more fast solid-state storage devices or mediums configured to store instructions and information used by CPU 505 to perform certain functions, methods, flowchart operations, and processes related to embodiments of the present disclosure. Storage 520 may be a volatile or nonvolatile, magnetic, semiconductor, tape, optical, or other type of storage device or computer-readable storage medium, including devices such as CDs and DVDs, meant for long-term storage.

In the illustrated embodiment, memory 510 contains one or more programs or subprograms 515 loaded from non-transitory storage 520 or from a remote system (not shown) that, when executed by CPU 505, perform various operations, procedures, functions, processes, or methods consistent with the present disclosure. Alternatively, CPU 505 may execute one or more programs located remotely from system 500. For example, system 500 may access one or more remote programs via network 535 that, when executed, perform functions and processes related to or implementing embodiments of the present disclosure.

In one embodiment, memory 510 may include a program(s) 515 that implements a system, such as a program that implements flowchart 300 and 400, and the components depicted in FIGS. 1 and 2. In some embodiments, memory 510 may also include other programs or applications that implement other methods and processes that provide ancillary functionality to the disclosure.

Memory 510 may be also be configured with other programs (not shown) unrelated to the disclosure and/or an operating system (not shown) that performs several functions well known in the art when executed by CPU 505. By way of example, the operating system may be Microsoft Windows™, Unix™, Linux™, an Apple Computers™ operating system, or other operating system. The choice of operating system, and even to the use of an operating system, is not critical to the disclosure.

I/O device(s) 525 may comprise one or more input/output devices that allow data to be received and/or transmitted by system 500. For example, I/O device 525 may include one or more input devices, such as a keyboard, track pad, touch screen, mouse, and the like, that enable data to be input via a user interface as discussed with regard to FIG. 2 and further depicted in FIGS. 5-6. Further, I/O device 525 may include one or more output devices, such as a display screen, CRT monitor, LCD monitor, plasma display, printer, speaker devices, and the like, that enable data to be output or presented to a user. I/O device 525 may also include one or more digital and/or analog communication input/output devices that allow computing system 500 to communicate, for example, digitally, with other machines and devices, for example, when computing system 500 is acting as a web server. Other configurations and/or numbers of input and/or output devices may be incorporated in I/O device 525.

In the embodiment shown, system 500 is connected to a network 535 (such as the Internet, a private network, a virtual private network, or other network), which may in turn be connected to various systems (e.g., third party data provider servers) and computing machines, such as a desktop computer, smart phone, tablet computer or laptop computer of a user 512 who wishes to utilize system 500. In general, system 500 may input data from external machines and devices and output data to external machines and devices via network 535.

A database 530 may also be used in conjunction with system 500. In the embodiment shown, a standalone database external to system 500 may be used. In other embodiments, a database may be hosted by system 500. The database may be used to manage and store data used to implement systems and methods consistent with the disclosure. For example, the database 530 may implemented as storage 185 and 210. By way of example, such a database may be an Oracle™ database, a Sybase™ database, or other relational database. Systems and methods consistent with the disclosure, however, are not limited to separate data structures or databases, or even to the use of a database or data structure.

It may be appreciated that the processed discussed herein, including 300 and 400, may be implemented in the context of a non-transitory computer-useable medium that contains a program product.

While the present disclosure has been particularly shown and described with reference to examples, it will be understood by those skilled in the art that various changes in form and detail may be made therein without departing from the spirit and scope of the disclosure.

While the teachings have been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, certain steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” Those skilled in the art will recognize that these and other variations are possible within the spirit and scope as defined in the following claims and their equivalents.

1. A computer-implemented method comprising:
determining, via a processor, that spot processing is enabled;
determining a spot color name;
determining a spot color library based on the spot color name;
accessing, via a processor, a profile based on the determination that spot processing is enabled, the profile including a plurality of private tags, each of the plurality of private tags identifying a gamut mapping strategy of a respective spot color library;
identifying, via a processor, a private tag from the plurality of private tags in the profile, wherein the private tag of the plurality of private tags identifies a gamut mapping strategy for the spot color library of the spot color name; and
converting Lab values based on the identified private tag of the plurality of private tags.

2. The computer-implemented method of claim 1, wherein:
the spot color name is one of PANTONE, DIC, and TOYO.

3.-4. (canceled)

5. The computer-implemented method of claim 1,
wherein the profile is a spot color library profile, and wherein identifying the private tag in the profile includes:
selecting an attribute; and
identifying the private tag from a plurality of private tags based on the selected attribute.

6. The computer-implemented method of claim 5, wherein the attribute is selected based on an object to be rendered.

7. The computer-implemented method of claim 5, wherein the attribute is selected based on a user input.

8. An apparatus, comprising:
a memory storing a set of instructions; and
a processor, to execute the stored set of instructions that, when executed by the processor, perform a method to:
determine, via a processor, that spot processing is enabled;
determine a spot color name;
determine a spot color library based on the spot color name;
access, via a processor, a profile based on the determination that spot processing is enabled, the profile including a plurality of private tags, each of the plurality of private tags identifying a gamut mapping strategy of a respective spot color library;
identify, via a processor, a private tag from the plurality of private tags in the profile, wherein the private tag of the plurality of private tags identifies a gamut mapping strategy for the spot color library of the spot color name; and
convert Lab values based on the identified private tag of the plurality of private tags.

9. The apparatus of claim 8, wherein the spot color name is one of PANTONE, DIC, and TOYO.

10.-11. (canceled)

12. The apparatus of claim 8,
wherein the profile is a spot color library profile of the determined spot color library, and wherein identifying the private tag in the profile includes:
selecting an attribute; and
identifying the private tag from a plurality of private tags based on the selected attribute.

13. The apparatus of claim 12, wherein the attribute is selected based on an object to be rendered.

14. The apparatus of claim 12, wherein the attribute is selected based on a user input.

15. A non-transitory computer-readable medium, storing a set of instructions, executable by a processor, to perform a method to:
determine, via a processor, that spot processing is enabled;
determining a pot color name;
determining a spot color library based on the spot color name;
access, via a processor, a profile based on the determination that spot processing is enabled, the profile including a plurality of private tags, each of the plurality of private tags identifying a gamut mapping strategy of a respective spot color library;
identify, via a processor, a private tag from a plurality of private tags in the profile, wherein the private tag of the plurality of private tags identifies a gamut mapping strategy for the spot color library of the spot color name; and
convert Lab values based on the identified private tag of the plurality of private tags.

16. The non-transitory computer-readable medium of claim 15, wherein the spot color name is one of PANTONE, DIC, and TOYO.

17.-18. (canceled)

19. The non-transitory computer-readable medium of claim 15, wherein the profile is a spot color library profile of the determined spot color library, and wherein to identify the private tag in the profile is to:
select an attribute; and
identify the private tag from a plurality of private tags based on the selected attribute.

20. The non-transitory computer-readable medium of claim 19, wherein the attribute is selected based on an object to be rendered.

21. The non-transitory computer-readable medium of claim 19, wherein the attribute is selected based on a user input.
